(19) United States
(12) Patent Application Publication
(10) Pub. No.: US 2006/0130803 A1
(43) Pub. Date: Jun. 22, 2006

(54) Multiple-power engine device

(76) Inventor: Chun-Lin Tseng, Nantou City (TW)

Correspondence Address: LEONG C LEI, PMB # 1008, 1867 YGNACIO VALLEY ROAD, WALNUT CREEK, CA, 94598, US

(21) Appl. No.: 11/016,869

(22) Filed: Dec. 21, 2004

(51) Int. Cl. F02B 53/00; F01B 13/04; F04C 18/00; F04C 2/00

(52) U.S. Cl. 123/241; 123/243; 123/43 C; 418/262; 418/259; 418/266

(57) ABSTRACT

The present invention relates to a multiple-power engine device, and more particularly, to a cylinder mechanism comprising multi-sets of gear-drive eccentric top-raised cylinder drives inside an engine case being able to operate twice the processes of intake, compression, power and exhaust in a cycle to gain multiple of power output. The primary parts comprise one engine case, two cylinder bases, one multi-sets of gear-drive eccentric top-raised cylinder drives, two inner-teeth idle gearwheels, one fixed external gearwheel, one driving gear shaft, two eight-claw shape and annular shape anti-leak cylinder gaskets, one bearing and three small gears intermeshed with inner teeth of the inner-teeth idle gearwheel. According to assembly of above-described parts, a generator is able to start and drive the driving gear shaft, coupled with the three small gears inside a inner-teeth idle gearwheels to drive rotating the inner-teeth idle gearwheels and the two cylinder bases locked together with the inner-teeth idle gearwheels, where the two small gears in one of the multi-set of gear-drive eccentric top-raised cylinder drives intermesh with and encircle the two fixed external gears. Thus, the engine is driven and then operates under the explosion output processes of intake, compression, power and exhaust, which raises top the multi-sets of gear-drive eccentric top-raised cylinder drives by compression and explosion and bends multi-set driving arms by gearing eccentrically, so as to generate re-acceleration driving power by itself. The continuous rotation engine is able to drive rotating the multi-sets of gear-drive eccentric top-raised cylinder drives and gain double kinetic energy in a 360 degree cycle from operating twice the processes of intake, compression, power and exhaust for increasing the operating speed of the cylinder drives themselves with only a short distance movement and enhancing power output instantly, so as to increase the vehicle engine speed continuously and then relatively to reduce the basic fuel consumption less than half of a traditional vehicle does.

### BACKGROUND OF THE INVENTION

(a) Technical Field of the Invention

The present invention relates to a multiple-power engine device and the primary parts comprise:
(1) An engine case formed in an inverted T-shape having two sets of diametrically symmetrical intake holes, exhaust holes and sparkling plug screw holes on outer surfaces of a round case of the engine case, the outer surfaces fabricated to a wave-like indented shape, two diametrically symmetrical cooling water holes and several screw holes on open end surface of the round case, and two sets of diametrically symmetrical air-pressurized thrust mesh holes in the same pitch on inner surface of the round case;
(2) Two cylinder bases formed and shaped like two flywheel bases having eight sets of containing crooked concaved cells formed an eight-claw convex surface on one side of each cylinder base, the eight-claw surface facing to the another one, pin holes formed at the bottom of each containing crooked concaved cell, bearing holes formed in the cylinder bases center, and two concaved through rooms formed on the other side of cylinder bases, opposite to eight-claw surface, penetrating close ends of each containing crooked concaved cell;
(3) Eight sets of gear-drive eccentric top-raised cylinder drives, each having a plane drive body, a driving arm and two small gears disposed bisymmetrically at the bottom of the driving arm, the plane drive body having an arc concavity on its arc upper surface in order to increase air capacity and an concaved groove on its lower end for the use of containing one end of the driving arm when bending;
(4) Two sets of fixed external gearwheels having three bolts in the same pitch extending from one side of themselves;
(5) Two sets of inner-teeth idle gearwheels having through holes in the same pitch on both sides;
(6) Two sets of three small gears forming two driving gears, the three small gears inserted into the three bolts of the fixed external gearwheel and intermeshed with the inner teeth of the inner-teeth idle gearwheel;
(7) A driving gear shaft with two gears disposed in bisymmetrical location;
(8) An eight-claw shape anti-leak cylinder gasket having three bolt holes formed on each claw and a through hole in the center; and
(9) An annular shape anti-leak cylinder gasket having cooling water holes and screw holes disposed corresponding to those holes on the engine case open-end surface.

An embodiment of installation of the present invention comprises: disposing the eight sets of gear-drive eccentric top-raised cylinder drives inside the eight containing crooked concaved cells of the two flywheel cylinder bases, pining eight pins into the pin holes at the bottom of the eight containing crooked concaved cells, interposing the eight-claw shape anti-leak cylinder gasket between the two cylinder bases, inserting sixteen sets of two long bolts from several sets of bolt holes on one of the flywheel cylinder base into the bolt holes on the eight-claw faces of the other flywheel cylinder base so as to fixed two cylinder bases as one unity; where one bearing disposed in the middle of the joint surface of the two flywheel cylinder bases bearing holes previously; further disposing one fixed external gearwheel and one inner-teeth idle gearwheel in the concaved through room of each cylinder base separately, sliding three small gears into the bolts on the other fixed external gearwheels and intermeshing them with the inner teeth of the inner-teeth idle gearwheel; where outer teeth of each fixed external gearwheel gearing into the two symmetric small gears of each gear-drive eccentric top-raised cylinder drive; eventually utilizing the driving gear shaft penetrating through the three small gears assembled on the inner-teeth idle gearwheel to another three small gears on the other side, intermeshing the two small gears of the driving gear shaft with two sets of three small gears, disposing foregoing assembled mechanism in the engine case, covering the assembly with the annular shape anti-leak cylinder gasket and then an engine cover on the engine round case, and fixing above assembly by screws to complete the whole engine installation processes.

Another embodiment of the engine operation mechanism of the present invention comprises: utilizing a generator to start the driving gear shaft, coupled with the three small gears on the inner-teeth idle gearwheels to drive rotating the inner-teeth idle gearwheels and the cylinder bases locked together with the inner-teeth idle gearwheels, the two small gears sets in the eight sets of the gear-drive eccentric top-raised cylinder drives then meshing with and encircling the two fixed external gearwheels, the engine being started here and then operating under the explosion output processes of intake, compression, power and exhaust which raise top the eight sets of gear-drive eccentric top-raised cylinder drives by compression and explosion and bends the eight driving arms by gearing eccentrically, so as to generate re-acceleration driving power to rotate the engine itself, and the continuous rotation engine being able to drive rotating the eight sets of the gear-drive eccentric top-raised cylinder drives and enhance power output instantly within a 360 degree cycle operating twice the processes of intake, compression, power and exhaust, so as to increase the vehicle engine speed continuously and relatively reduce the basic fuel consumption less than half of a traditional vehicle does.

The rotation flywheel cylinder of the present invention relates to a rotating cycle of the eight sets of the gear-drive eccentric top-raised cylinder drives being able to operate and output twice vehicle power cycles of intake, compression, power and exhaust, so as to increase the operation speed of the cylinder drives themselves with only a short distance movement, further to enhance the rotation acceleration force, and then relatively to reduce the fuel consumption hugely.

(b) Description of the Prior Art

In general, car industry has been existing for over two hundred years since it was first created in the year of 1770. According to the rapid development of the industrialization, disposal income of human being increased, accompanied with the development of cars as a transportation tool in modern world. As time goes by and development of the world, the car industry has had many outstanding breakthroughs continuously no matter in quality or quantity during the past two hundred years, not only the outline design for car looks but also the high power engine, comfort inside facilities and enhanced performance, and has guided the society to a car-based modern life. Thus, human being now can not live without using a car in such an industrialized and modern world and enjoys a psychologically smaller world that never happened before.

Nowadays, the leaping high-speed development of the car industry is beyond comparison with what the development of low-speed car is in old days. In such an industrialized world stressing on high speed, development of road construction is so important that all roads have been specially designed for the high speed use. Thus, it has become a main target for the car industry to develop a car with high driving power and low fuel consumption, which human being is able to drive the car simply and comfortably in the high speed road. However, on the contrary, to focus on present car engine development, the car still stays in the stage of reciprocating piston structures and is not able to release from the bottleneck of this original designed structure.

In terms of the principle of the mechanical dynamics, the traditional reciprocating piston-cylinder engine (as shown in FIG. 1) usually exists a stagnating dead angle time when being accelerated rotation, which means zero instantaneous velocity at that point. While the engine are accelerated the second time, the power energy is wasted here for the continuing increase of the dead angle time.

According to the operation principle of the traditional reciprocating piston-cylinder engine, a four-stroke engine is able to output one thrust while the piston operates four strokes and the crankshaft rotates two cycles (720 degrees).

However, the design exists defects, comprising:
(1) Gap time problem, reducing instantaneous thrust efficiency during the four-stroke processes;
(2) Long operating time problem, influencing power efficiency because of a complete power shaft output (360 degree) requiring twice cycles (720 degree) of the four-stroke processes of intake, compression, power, exhaust in the cylinder;
(3) Much cooling water to cool down the engine because of heat generated from the piston reciprocation at fixed spot easily damaging the cylinder;
(4) Too many parts increasing the cost of maintenance and repair, including one sparkling plug, two valve sets, and a camshaft, in such a complex mechanism;
(5) Up to 70% power loss from the mechanical operation and heat vaporization, and feedback of the engine power output because of the large-sized, heavy-weighted engine and the crank operating 720 degree to complete power output only once;
(6) Fuel consumption raising sharply while the engine rotation speed and torque being increased because of its original design limitation; and
(7) Heavy vibration amplitude problem resulting from the cylinder operating independently on the crank.

Additionally, in another embodiment of prior arts, a rotary engine (as shown in FIG. 2), a triangle-like rotor rotates inside the engine to complete the four-stroke processes of intake, compression, power, and exhaust and then to output power from a eccentric shaft disposed in the engine center, where the rotor operating a cycle is able to complete three times the four-stroke processes of intake, compression, power, and exhaust so as to enhance the engine operation power largely.

However, the design also exists defects, comprising:
(1) An air-sealing problem resulting in a required change of the rotor sealant in every 6,000 kilometer, or a further compression ratio problem being possibly happened;
(2) An incomplete combustion problem of fuel and air resulting in huge fuel consumption because of high engine rotating speed from the short rotation shaft;
(3) Multiple increase of fuel consumption ratio problem when operated in small torque together with high speed;
(4) High vibration amplitude problem resulting from the eccentric operation of the power output shaft;
(5) Much exhaust gas problem in high speed operation because low fuel-air-ratio causing incomplete combustion; and
(6) Much fuel consumption problem even though it being small-sized, light-weighted with less parts, without mechanical operation loss and feedback problem of the engine output power.

Hence, as above description, it is known that the traditional reciprocating engine has low power efficiency from the limited operation pattern and the rotary engine has serious fuel consumption problem while it improves and raises engine operation efficiency. In other words, both engines are not able to balance between output power and fuel consumption. We can hardly regard them as ideal design and still need to find ways to solve those problems.

### SUMMARY OF THE INVENTION

The first primary purpose of the present invention is to provide a leverage from the principle of inertia rotation to create a multiple-power engine device, which an independent cylinder drive comprises two continuous cycles of a four-stroke engine (intake, compression, power, exhaust) in one synchronized operation cycle, so as to power up one by one and output high thrust instantly.

The second primary object of the present invention is to provide a multiple-power engine device with the same propeller shaft and synchronized power output, which several cylinders are connected together on the same propeller shaft and formed a multi-cylinder engine, so as to output instant high thrust and torque by adding up the output force operated on the same shaft.

The third primary object of the present invention is to provide a multiple-power, single connection engine device being able to operate normally even though one of the connected cylinder is damaged, which one of the connected cylinder on the same shaft is damaged and the other cylinders is till able to output power continuously and normally.

The fourth primary object of the present invention is to provide a multiple-power engine device with each cylinder drive being able to operate twice the four strokes in one cycle, which eight sets of independent and continuously-operated cylinder drives are disposed in the engine and operates twice the four strokes, intake, compression, power and exhaust cycles synchronizedly in one rotation. Additionally, two sparkling plugs disposed in the engine are synchronizedly fired to make fuel exploded in the same time and to reach the purpose of high adding-up thrust force.

The fifth primary object of the present invention is to provide a multiple-power engine device being able to operate with one-point firing under the high speed inertia rotation, which the engine is able to operate by firing only one-point under the high speed inertia rotation, so as to reduce the fuel consumption.

The sixth primary object of the present invention is to provide a spot-rotating, multiple-power engine device with the same center and shaft, which eight sets of independent cylinder drives in the flywheel rotate in the same center and shaft causing no eccentric vibration amplitude problems and do not fully contact inner cylinder wall causing no horning and air-sealing problems, so as to reduce the cost of maintenance and repair.

The seventh primary object of the present invention is to provide a multiple-power engine device with high speed inertia acceleration, which the flywheel cylinder rotates a cycle (360 degrees) and transmits gear power to the driving gear shaft to rotate four cycles (1,440 degree), that is, the engine speed is increased continuously and the basic fuel consumption is relatively reduced sharply while the engine generates power twice.

The eighth primary object of the present invention is to provide a multiple-power engine device without fearing car flood, which the flywheel cylinder engine generating twice power cycle (intake, compression, power, exhaust) requires an exhaust holes disposed at the bottom and the exhaust hole is able to drain water away by moving the car back and forth whenever a car is flooded, so as not to be hauled and repaired.

The ninth primary object of the present invention is to provide a small-sized, light-weighted multiple-power engine device, which the cylinder is fabricated to eight sets of independently rotating cylinder drives being small-sized and light-weighted, so as to prevent the engine from load anti-lock and gain multiple of kinetic energy while the engine outputs power.

An engine device is able to output power anytime by a certain operation process reciprocating continuously. The process is named cycle comprising four basic processes, intake process, compression process, power process and exhaust process.

Because of the engine defects in the prior arts, the inventor referring to his own experience and other drivers' opinions tried hard to gather experts with different majors and experience to brainstorm solutions for the defects, analyze vehicle and engine structures, improve and test prototypes countless times. Eventually, the present invention, a multiple-power engine structure, is invented after several years' research.

A rotation flywheel cylinder of the present invention comprises eight sets of gear-drive eccentric top-raised cylinder drives which are able to operate twice the vehicle output power processes of intake, compression, power and exhaust in a rotation cycle, so as to increase the operating speed of the cylinder drives themselves with only a short distance movement, further to raise accelerating rotation force and then relatively to reduce the fuel consumption hugely.

Accordingly, traditional cranks and crankshaft journals have shorter drive arms length than the present invention. A flywheel cylinder drive set of the present invention transmits power directly to the propeller shaft after fuel exploded inside, which has multiple drive arm length compared with the traditional one, so as to reduce fuel consumption sharply when operation.

Thus, the present invention relates to a multiple-power engine which is safe and with multiple of power output, so as to reach the purpose of low fuel consumption together with high speed.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a plane view of a traditional reciprocating piston cylinder engine in prior arts;

FIG. 2 is a plane view of a traditional rotary engine in prior arts;

FIG. 3 is a three-dimensional schematic view of the present invention, illustrating an engine device;

FIG. 4 is a three-dimensional, exploded, schematic view of the present invention, illustrating the engine device;

FIG. 5 is a cross sectional plane view of the present invention, illustrating assembly parts of the engine device;

FIG. 6 is a partially assembled and exploded, cross sectional plane view of FIG. 5;

FIG. 7 is a cross sectional plane view of the present invention, illustrating assembly of the engine device;

FIG. 8 is a three-dimensional, exploded, schematic view of the present invention, illustrating one of the eight sets of gear-drive eccentric top-raised cylinder drives;

FIG. 9 is a three-dimensional plane view of the present invention, illustrating a drive arm and two small drive gears of the eight sets of gear-drive eccentric top-raised cylinder drives;

FIG. 10 is a schematic view according to an embodiment of the present invention, illustrating operation mechanism of the eight sets of gear-drive eccentric top-raised cylinder drives, fixed external gearwheel, inner-teeth idle gearwheel, three small drive gear and main driving gear;

FIG. 11 is a schematic plane view according to another embodiment of the present invention, illustrating plane operation mechanism; and

FIGS. 12A and 12B is a three-dimensional schematic view according to another embodiment of the present invention, illustrating an engine attached with two or three sets of other engines.

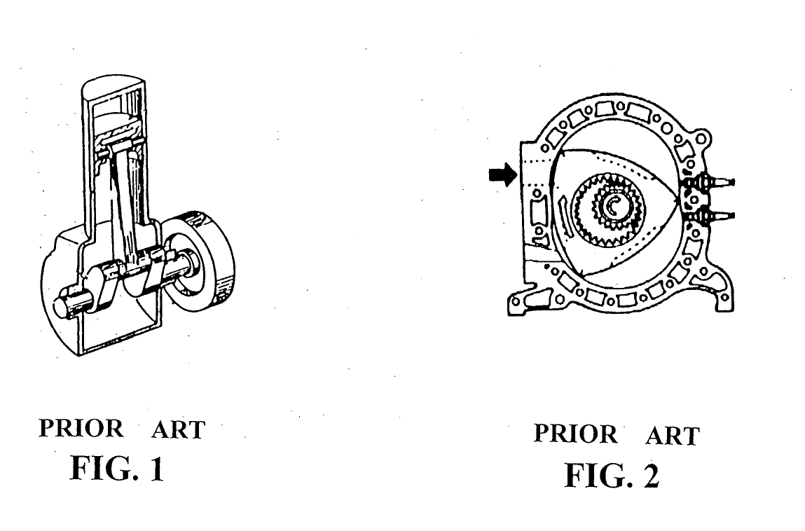

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

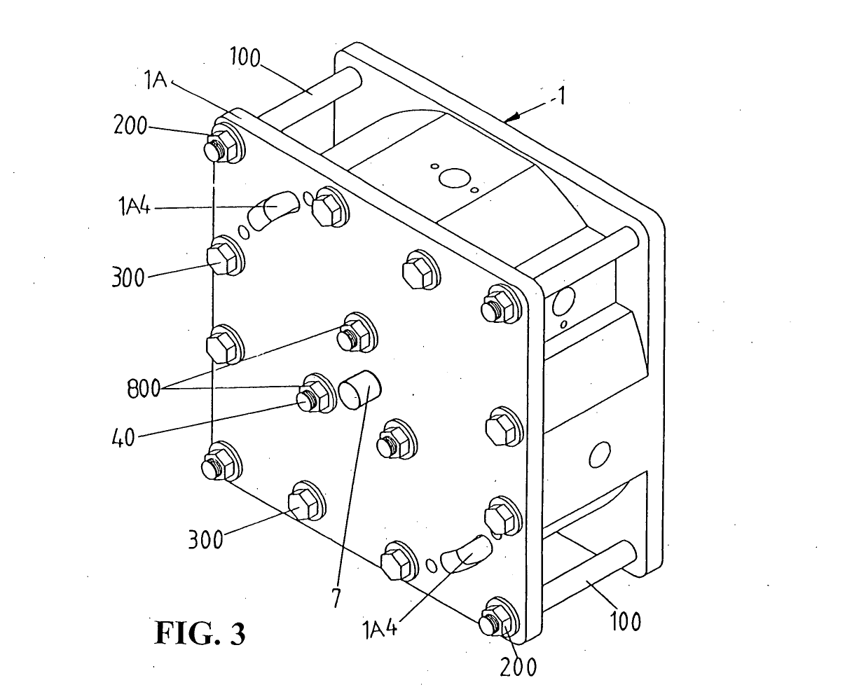

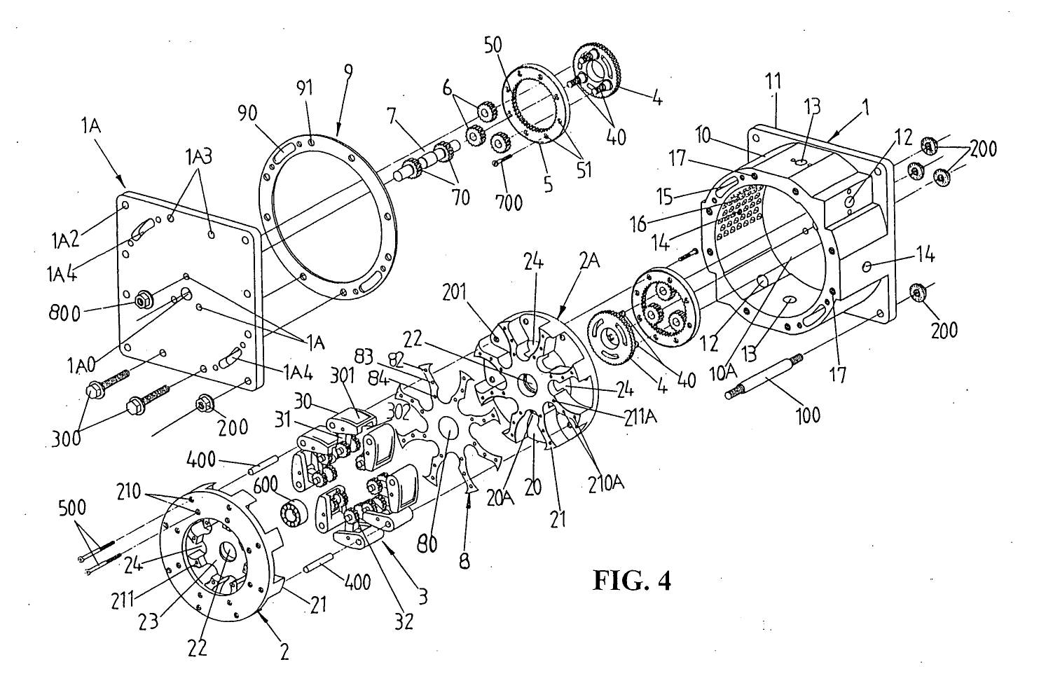

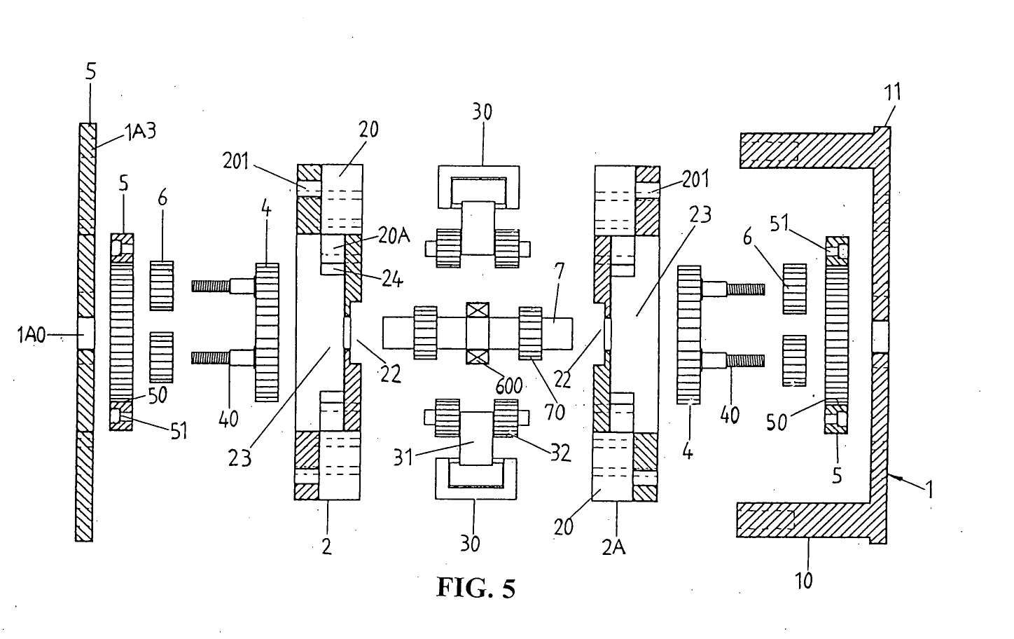

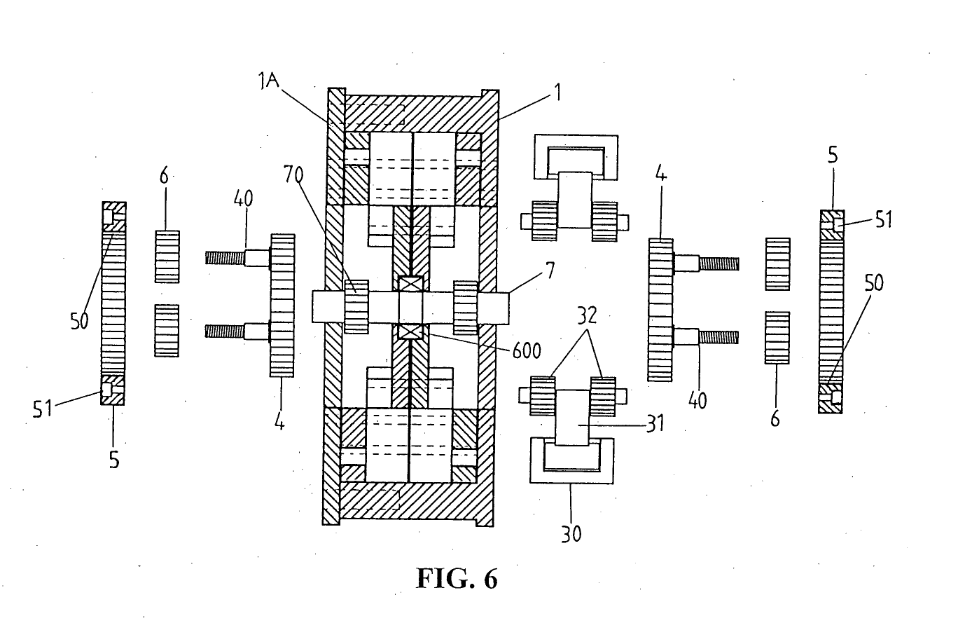

FIGS. 3-6 are three-dimensional, three-dimensional exploded, exploded plane and assembled cross sectional plane views of an engine in the present invention.

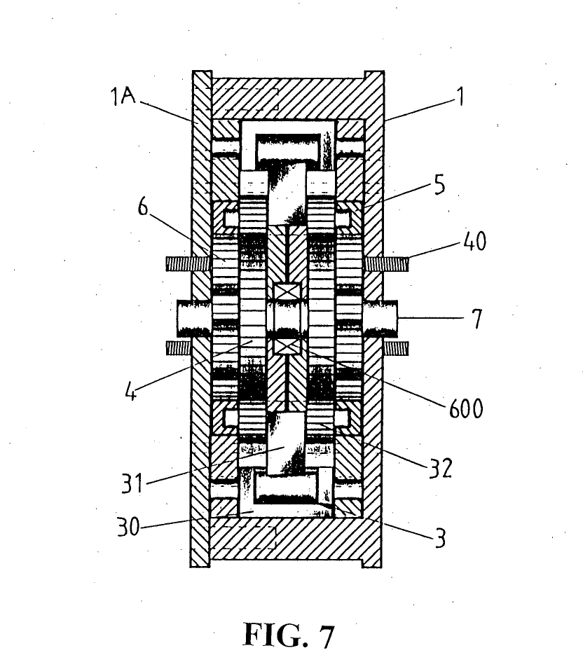

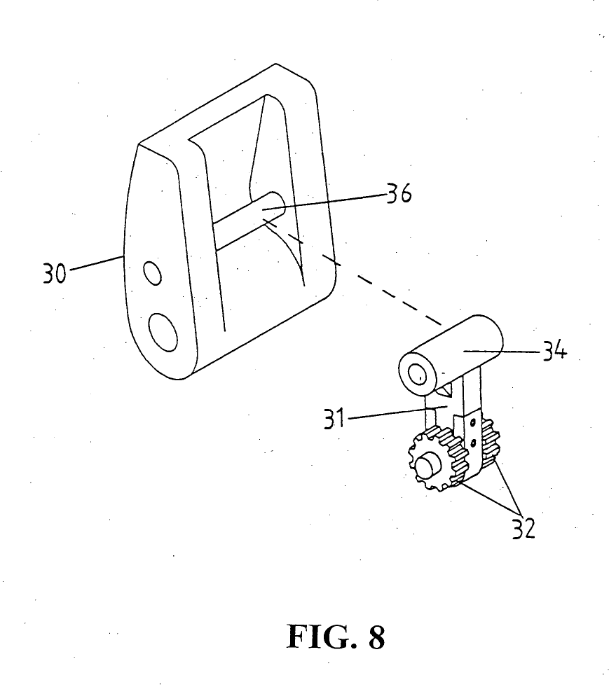

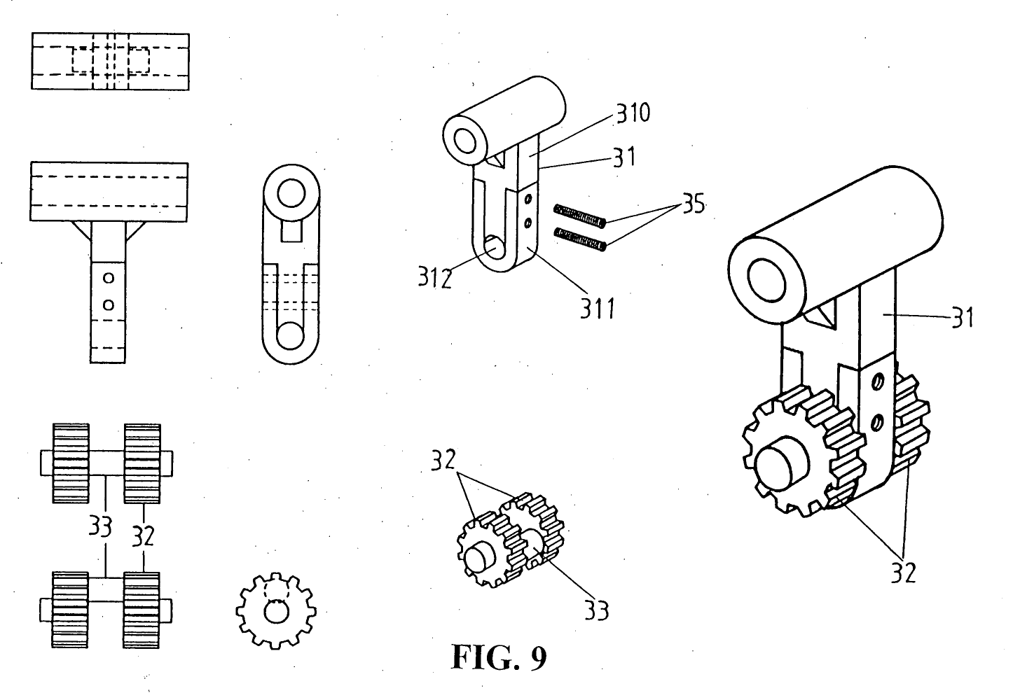

The main structure of the engine comprises:
(1) An engine case 1 having around case 10 and a square base 11 formed in an inverted T-shape, the round case 10 having outer surfaces fabricated to a wave-like indented shape and an engine chamber 10A inside, the outer surfaces having two diametrically symmetrical intake holes 12, exhaust holes 13 and two sparkling plug screw holes 14, the round case 10 open end surface having two diametrically symmetrical cooling water holes 15 inside and several screw holes 101, the round case 10 inner surface having two sets of diametrically symmetrical air-pressurized thrust mesh holes 16 disposed in the same pitch; additionally, the square base 11 having four corner holes 110 at its four corner ends; furthermore, the two sparkling plug screw holes 14 having sparkling plugs 1000 screwed in, two sets of the intake holes 12, the air-pressurized thrust mesh holes 16, the sparkling plug screw holes 14 and the exhaust holes 13 sequentially disposed in a circle in accordance with two cycles of the processes of intake, compression, power, exhaust, and one of the exhaust hole 12 disposed exactly at the bottom of the engine chamber 10A to drain water away whenever the whole engine flooded;
(2) Two cylinder bases 2, 2A formed and shaped like two flywheel bases, having eight sets of containing crooked concaved cells 20 formed in an eight-claw convex surface 21 on one side of each cylinder base 2, 2A facing another eight sets, the eight-claw convex surface 21 of the cylinder base 2 having two bolt holes 210 and a bolt hole 211 while the other eight-claw convex surface 21 of the cylinder base 2A having two bolt holes 210A and a bolt hole 211A, each crooked concaved cell 20 extending to form a sub-cell 20A and having a pin hole 201 formed at the bottom, the cylinder bases 2, 2A centers having two bearing holes 22; further, the two cylinder bases 2, 2A having one concaved through room 23 separately on the other side of eight crooked concaved cells 20 penetrating close ends of each containing crooked concaved cell 20 and forming eight indents 24;
(3) Eight sets of gear-drive eccentric top-raised cylinder drives 3 (as shown in FIGS. 7 and 8), each having a plane drive body 30, a driving arm 31 and two small gears 32 disposed bisymmetrically at the bottom of the driving arm 31, the plane drive body 30 having an arc concavity 301 formed on its arc upper surface to increase air capacity and an concaved groove 302 formed on its lower surface for the use of containing the two small gears 32 disposed at one end of the driving arm 31 when bending; the driving arm 31 comprising two arm bodies 310, 311 connected each other by two screws 35, a pin hole 312 at the bottom for the use of pining a eccentric shaft 33 of the two bisymmetrical small gears 32 to rotate eccentrically; further, the upper arm body 310 of the driving arm 31 having a hollow cylinder 34 on the top pinned at the concaved groove 302 of the plane drive body 30;
(4) Two sets of fixed external gearwheels 4 having three bolts 40 with the same pitch extending from one side of them;
(5) Two sets of inner-teeth idle gearwheel 5 having inner teeth 50 formed along their inner diameter and through holes 51 with the same pitch on their both sides;
(6) Two sets of three small gears forming two driving gear 6, the three small gears of the driving gear 6 inserted into the three bolts 40 of the fixed external gearwheel 4 and intermeshed with the inner teeth 50 of the inner-teeth idle gearwheel 5;
(7) A driving gear shaft 7 with two gears 70 disposed bisymmetrically; an eight-claw shape anti-leak cylinder gasket 8 having a through hole 81 in the center and three holes 82, 83, and 84 formed on each claw face;
(8) An annular shape anti-leak cylinder gasket 9 having cooling water holes 90 and several bolt holes 91 disposed corresponding to those holes on the engine case 1; and
(9) A cylinder cover 1A having a through hole 1A0 in the center, three holes 1A1 disposed in a triangle above the through hole 1A0, four corner holes 1A2 at its four corner ends, several sets of two holes 1A3 disposed in the middle of the four ends, and two cooling water holes 1A4 disposed corresponding to the cooling water holes 15 on the round case 10 of the engine case 1.

An embodiment of installation of the present invention comprises: disposing eight sets of gear-drive eccentric top-raised cylinder drives 3 into the eight containing crooked concaved cells 20 of the two flywheel cylinder bases 2 separately, pining and fixing eight pins 400 into the pin holes 201 at the bottom of the eight containing crooked concaved cells 20 of the two flywheel cylinder bases 2, interposing an eight-claw shape anti-leak cylinder gasket 8 between the two cylinder bases 2, inserting sixteen sets of two long bolts 500 from the bolt holes 210 (that is, the bolt holes on the eight-claw convex surface 21) on one of the flywheel cylinder base 2, passing through the holes 82 and 83 on the eight claws faces of the eight-claw shape anti-leak cylinder gasket 8 into the bolt holes 210A on the eight-claw convex surface 21 of the other flywheel cylinder base 2A so as to fixed two cylinder bases 2 as one unity; where a bearing 600 disposed into the joint surface center in the two bearing holes 22 of the two flywheel cylinder bases 2, 2A previously; further disposing one fixed external gearwheel 4 and one inner-teeth idle gearwheel 5 in the concaved through room 23 of each cylinder base 2, 2A separately, inserting eight bolts 700 into the eight holes 51 on the inner-teeth idle gearwheel 5 through to the bolt holes 211 and 211A on the eight-claw convex surface 21 of the flywheel cylinder base 2A in order to fix all of them, sliding three small driving gears 6 into the bolts 40 on the fixed external gearwheels 4 while intermeshing with the inner teeth 50 of the inner-teeth idle gearwheel 5; where outer teeth of each fixed external gearwheel 4 gearing into the two bisymmetric small gears 32 of the gear-drive eccentric top-raised cylinder drives 3; eventually utilizing the driving gear shaft 7 penetrating through the three small driving gears 6 assembled on the inner teeth 50 of the inner-teeth idle gearwheel 5 to another three small gears 6 on the inner teeth 50 of the inner-teeth idle gearwheel 5 in the other side flywheel cylinder base 2A and intermeshing the two small gears 70 of the driving shaft 7 with two sets of three small gears 6, disposing above assembled mechanism in the engine case 1, covering the assembly with the annular shape anti-leak cylinder gasket 9 and then a engine cover 1A on the round case 10 of the engine case 1, and fixing above parts by long bolts 100 and nuts 200 to complete the whole engine installation processes.

The above-described eight containing crooked concaved cells 20 of the flywheel cylinder base 2 are disposed and eccentrically pinned one gear-drive eccentric top-raised cylinder drive 3 separately, where the two eccentrically-rotating driven small gears 32 of the driving arm 31 of the gear-drive eccentric top-raised cylinder drive 3 are disposed inside the corresponded sub-cell 20A, and a large-sized concaved through room 23 is formed on the outer surfaces of the two flywheel cylinder bases 2 separately to penetrate the containing crooked concaved cells 20 and the sub-cells 20A of the two flywheel cylinder bases 2 forming indents 24 and to contain one fixed external gearwheel 4 and one inner-teeth idle gearwheel 5.

The above-described eight sets of gear-drive eccentric top-raised cylinder drive 3 are disposed and independently pinned inside the eight containing crooked concaved cells 20 of the flywheel cylinder base 2, having an arc upper surface and the driving arm 31 connected to lower surface which is able to rotate free. The two small gears 32 at the bottom end of the driving arm 31 are disposed inside the corresponded sub-cell 20A extending from the containing crooked concaved cell 20. Additionally, the eight sets of gear-drive eccentric top-raised cylinder drives 3 are fixed inside the two cylinder bases 2 by inserting long bolts 500 from the bolt holes 210 on one of the flywheel cylinder base 2, passing through the eight-claw shape anti-leak cylinder gasket 8, into the bolt holes 210A on the surface of the other flywheel cylinder base 2A.

The above-described two fixed external gearwheels 4 are disposed into the concaved through rooms 23 on the outer sides of the two flywheel cylinder base 2 and intermeshes with two driven small gears 32 at the bottom end of the driving arm 31 of the flywheel cylinder base 2 through the eight indents 24 of the sub-cell 20A. Three bolts 40 are formed and extended from the outer surfaces of the two fixed external gearwheels 4 and each bolt 40 is inserted into one small driving gear 6 arranged and intermeshed with the inner teeth 50 of the inner-teeth idle gearwheel 5 so as to couple the small driving gear 6 with the inner-teeth idle gearwheel 5. The bolts 40 of the fixed external gearwheel 4 further penetrates the engine case 1 and the cover 1A to fix each other as one unity and to keep the fixed external gearwheel 4 fixed.

The above-described driving gear shaft 7 penetrates the common center of all mechanical parts mentioned above and includes two small gears 70 disposed in symmetric distant so as to intermesh with the three small driving gears 6 on the fixed external gearwheel 4. The bearing 600 is disposed in the middle section of the driving gear shaft 7.

The above-described engine cover 1A is fixed with the engine case 1 as one unity by disposing two double-thread bolt 100 between the engine case 1 and the engine cover 1A, penetrating through both the four corner holes 1A2 of the engine cover 1A and the four corner holes 110 of the engine case 1, and fixing with the nuts 200, where the three bolts 40 of the fixed external gearwheel 4 penetrates through the triangle-arranged through holes 1A1 to fixed with the nuts 800 and both shaft ends of the driving gear shaft 7 penetrates the through hole 1A0 of the engine cover 1A. Additionally, the combination strength of the of the engine cover 1A and the round case 10 is reinforced by fixing the screws 300 through the holes 1A3, two of a set, disposed in the middle of the four ends with the screw holes 17 on open end surface of the round case 10 of the engine case 1, so as to seal the engine chamber 10A of the above-described engine case 1. One annular shape anti-leak cylinder gasket 9 is interposed between the engine cover 1A and the round case 10 to reach air-sealing for the engine chamber 10A, so as to enable the above assembled mechanical parts operating in an air-sealing engine chamber 10A.

The structures of above-described parts are all symmetric in shape and distance.

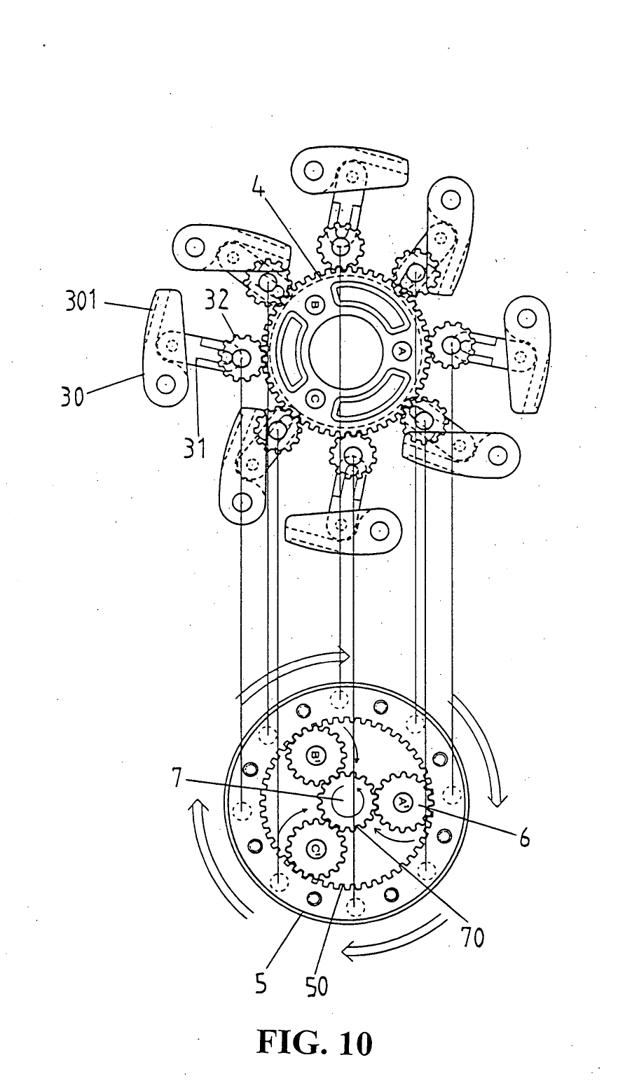

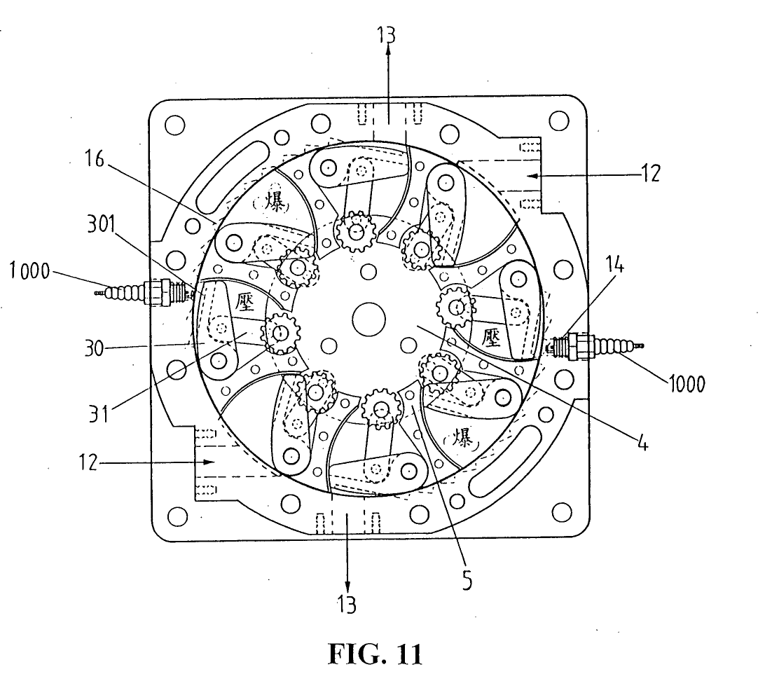

Another embodiment of engine mechanism of the present invention (as shown in FIGS. 10 and 11) comprises: utilizing a generator to start and drive the driving gear shaft 7 (not shown in the drawings), coupled with the three small gears 6 on the inner teeth 50 of inner-teeth idle gearwheels 5 to drive rotating the inner-teeth idle gearwheels 5 and the cylinder bases 2 locked together with the inner-teeth idle gearwheels 5; where the two small driven gears 32 on the driving arm 31 of the eight sets of the gear-drive eccentric top-raised cylinder drives 3 in the flywheel cylinder base 2 rotate eccentrically and encircle along the two fixed external gearwheels 4; while the engine being driven here and operating under the explosion output processes of intake, compression, power and exhaust to operate the eight sets of gear-drive eccentric top-raised cylinder drives 3, the engine chambers 10A being able to draw fuel from the intake hole 12 and then explode by the sparkling plug (not shown in Figure) in the sparkling plug screw hole 14 when the engine operating to the air-pressurized thrust mesh holes 16 section, then air pressure generating reaction force in the air-pressurized thrust mesh holes 16 section to thrust rotating the two flywheel cylinder bases 2 and two inner-teeth idle gearwheels 5 assembled on outer side of the flywheel cylinder bases 2, further the two inner-teeth idle gearwheels 5 gearing and driving the three small driving gears 6 in the fixed external gearwheel 5 to output power on the main driving gear shaft 7 to rotate in a high speed; where the eight sets of the gear-drive eccentric top-raised cylinder drives 3 rotate and operate to the exhaust holes 12 section to emit exhaust gas. During the whole operation processes, the flywheels cylinder bases 2 is able to rotate and complete the four-stroke processes of intake, compression, power and exhaust smoothly because the fixed external gearwheels 4 are fixed and kept still on the engine case 1 and the engine cover 1A, the small driven gears 32 of the eight sets of the gear-drive eccentric top-raised cylinder drives 3 are limited by intermeshing with the fixed external gearwheels 4, and the rotation relation of the three small driving gears on the three bolts 40 of the fixed external gearwheels 4 with the two inner-teeth idle gearwheels 5.

Furthermore, during the engine operation, because inner wall of the engine chamber 1A in the engine case 1 is disposed two sets of intake holes 11, air-pressurized thrust mesh holes 16, sparkling plug screw holes 13 and exhaust holes 12 corresponding to the eight sets of the gear-drive eccentric top-raised cylinder drives 3, the flywheel cylinder base 2 operating a cycle (360 degrees) is able to operate each cylinder drives 3 just two cycles. Moreover, because the main driving shaft 7 is thrust twice by the two processes of intake, compression, power and exhaust, and the gear ratio between the inner-teeth idle gearwheels 5 and the three small driven gears 6 is 64 to 16, the main driving shaft 7 is able to rotate four cycles (1440 degrees) and output four times power (equivalent to four times operation speed) during a rotation cycle of the flywheel cylinder base 2. Thus, the engine output power is increased sharply. Meanwhile the engine relatively generates no incomplete combustion problem because the four-stroke processes are very short and the engine has enough time to combust fuel and air. These bring the engine great benefits to reduce the fuel consumption and exhaust emission. The plane drive body 30 of the above-described eight sets of the gear-drive eccentric top-raised cylinder drives 3 raises top by compression and explosion so as to bend eight driving arms 31 by gearing eccentrically and generates re-acceleration driving power to rotate the engine itself While continuous rotation of the engine to drive multi-sets of the gear-drive eccentric top-raised cylinder drives mechanism and a 360 degree cycle to operate twice the processes of intake, compression, power and exhaust, the engine is able to gain enhanced power output instantly to increase the vehicle engine speed continuously and relatively consumes the basic fuel less than half of a traditional vehicle does.

Besides, because the flywheel cylinder bases 2 are dispose eight sets of the gear-drive eccentric top-raised cylinder drives 3 which acts on the same rotation object simultaneously, the cylinder drives 3 are still able to operate to keep engine output power continuously and normally and not to influence the engine whole performance even when a cylinder drive is damaged.

Furthermore, because the flywheel cylinder base 2 operating a cycle is able to force the eight sets of the gear-drive eccentric top-raised cylinder drives 3 to operate twice power cycles and an exhaust hole 11 is disposed at the bottom of the engine chamber 1A, the hole 11 is able to drain water away by moving the car back and forth and prevent inner parts from destroyed whenever a car is flooded.

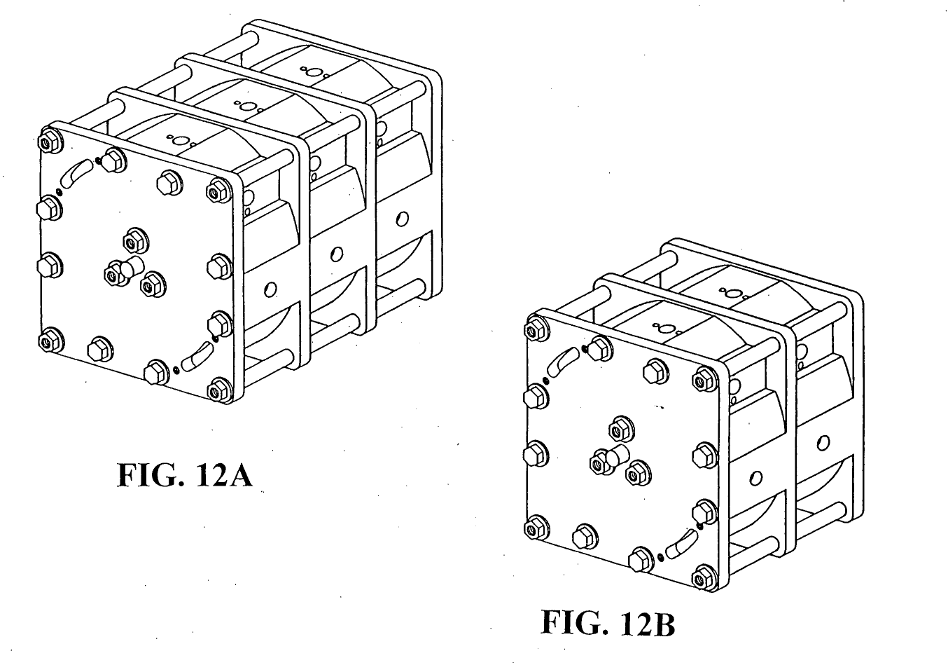

As shown schematically in FIGS. 12A and 12B, another embodiment of the present invention to attach two or three sets of engines. The main structure is to attach one set or several sets of cylinder bodies together on the same driving gear shaft so that a multi-cylinder engine is able to output power on the same shaft simultaneously to reach high thrust and torque instantly.

Thus, the present invention relates to a rotation flywheel cylinder, comprising eight sets of the gear-drive eccentric top-raised cylinder drives operating a cycle to output twice power of intake, compression, power and exhaust, so as to increase the engine operation speed with only a short distance movement of the cylinder drives, further to enhance its rotation acceleration force, and then relatively to reduce the fuel consumption hugely.

The benefits of the multiple-power engine of the present invention comprises:
(1) A multiple of the driving arm length compared with traditional engine to relatively reduce fuel consumption sharply, resulting from the principle of inertia rotation to add each power outputs of the independent cylinder drive during the flywheel cylinder engine rotation, which the independent cylinder drives being able to transmit power separately and directly to the driving gear shaft when fuel and air being exploded;
(2) A simple structure and symmetric parts to reduce abrasion and damage;
(3) An increased stroke distance to raise torque from the principle of inertia rotation in the flywheel cylinder;
(4) Two sparkling plug explosion to raise the explosion thrust and one sparkling plug explosion to reduce fuel consumption when operating in high speed;
(5) The flywheel cylinder being able to do intermissive operation to reduce fuel consumption and exhaust emission relatively when operating in high speed;
(6) No homing and air-sealing problems to reduce the maintenance cost because of the flywheel cylinder not fully contact inner cylinder wall;
(7) No vibration amplitude problem from pointed rotation;
(8) No engine overheat problem from non-pointed heating;
(9) The flywheel cylinder rotating a cycle to force twice the operating cycle of each cylinder drive and an exhaust hole at the bottom of it to drain water away easily by moving a car back and forth whenever a car being flooded;
(10) No engine output feedback problem from the heavy engine itself because of the small-sized and light-weighted engine design;
(11) The engine operating normally even one of the cylinder drive damaged because of eight cylinder drives acting on the same rotation object;
(12) Several engines being able to be attached together in one time;
(13) Availability for high power generators facilities;
(14) The flywheel rotating a cycle (360 degrees), the driving gear shaft rotating 1440 degrees (4 cycles) and the cylinder drive operating twice to increase the engine speed continuously and to reduce the basic fuel consumption hugely; and
(15) Two firing in two points when operating in low speed and one firing in one point to reduce power consumption.

To sum up, the multiple-power engine of the present invention has innovated flywheel cylinder which a rotating cycle of it is able to operate and output twice vehicle power cycle of intake, compression, power and exhaust and a short distance movement of the cylinder drives in it is able to increase power and the engine operating speed to save fuel consumption. These benefits are no doubt valuable and practical in terms of economy and meet the requirements of the patent application. Thus, it is intended to apply to a new model legally.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multiple-power engine device of the present invention and its primary parts, comprising:
an engine case formed in an inverted T-shape having two sets of diametrically symmetrical intake holes, exhaust holes and sparkling plug screw holes on outer surfaces of a round case of the engine case, the outer surfaces fabricated to a wave-like indented shape, two diametrically symmetrical cooling water holes and several screw holes on open end surface of the round case, and two sets of diametrically symmetrical air-pressurized thrust mesh holes in the same pitch on inner surface of the round case;
two cylinder bases formed and shaped like two flywheel bases having eight sets of containing crooked concaved cells formed an eight-claw convex surface on one side of each cylinder base, the eight-claw surface facing to the another one, pin holes formed at the bottom of each containing crooked concaved cell, bearing holes formed in the cylinder bases center, and two concaved through rooms formed on the other side of cylinder bases, opposite to eight-claw surface, penetrating close ends of each containing crooked concaved cell;
eight sets of gear-drive eccentric top-raised cylinder drives, each having a plane drive body, a driving arm and two small gears disposed bisymmetrically at the bottom of the driving arm, the plane drive body having an arc concavity on its arc upper surface in order to increase air capacity and an concaved groove on its lower end for the use of containing one end of the driving arm when bending;
two sets of fixed external gearwheels having three bolts in the same pitch extending from one side of themselves;
two sets of inner-teeth idle gearwheels having through holes in the same pitch on both sides;
two sets of three small gears forming two driving gears, the three small gears inserted into the three bolts of the fixed external gearwheel and intermeshed with the inner teeth of the inner-teeth idle gearwheel;
a driving gear shaft with two gears disposed in bisymmetrical location;
an eight-claw shape anti-leak cylinder gasket having three bolt holes formed on each claw and a through hole in the center; and
an annular shape anti-leak cylinder gasket having cooling water holes and screw holes disposed corresponding to those holes on the engine case open end surface;
an embodiment of installation of the present invention comprising: disposing the eight sets of gear-drive eccentric top-raised cylinder drives inside the eight containing crooked concaved cells of the two flywheel cylinder bases, pining eight pins into the pin holes at the bottom of the eight containing crooked concaved cells, interposing the eight-claw shape anti-leak cylinder gasket between the two cylinder bases, inserting sixteen sets of two long bolts from several sets of bolt holes on one of the flywheel cylinder base into the bolt holes on the eight-claw faces of the other flywheel cylinder base so as to fixed two cylinder bases as one unity; where one bearing disposed in the middle of the joint surface of the two flywheel cylinder bases bearing holes previously; further disposing one fixed external gearwheel and one inner-teeth idle gearwheel in the concaved through room of each cylinder base separately, sliding three small gears into the bolts on the other fixed external gearwheels and intermeshing them with the inner teeth of the inner-teeth idle gearwheel; where outer teeth of each fixed external gearwheel gearing into the two symmetric small gears of each gear-drive eccentric top-raised cylinder drive; eventually utilizing the driving gear shaft penetrating through the three small gears assembled on the inner-teeth idle gearwheel to another three small gears on the other side, intermeshing the two small gears of the driving gear shaft with two sets of three small gears, disposing foregoing assembled mechanism in the engine case, covering the assembly with the annular shape anti-leak cylinder gasket and then an engine cover on the engine round case, and fixing above assembly by screws to complete the whole engine installation processes;
another embodiment of the engine operation mechanism of the present invention comprising: utilizing a generator to start the driving gear shaft, coupled with the three small gears on the inner-teeth idle gearwheels to drive rotating the inner-teeth idle gearwheels and the cylinder bases locked together with the inner-teeth idle gearwheels, the two small gears sets in the eight sets of the gear-drive eccentric top-raised cylinder drives then meshing with and encircling the two fixed external gearwheels, the engine being started here and then operating under the explosion output processes of intake, compression, power and exhaust which raise top the eight sets of gear-drive eccentric top-raised cylinder drives by compression and explosion and bends the eight driving arms by gearing eccentrically, so as to generate re-acceleration driving power to rotate the engine itself, and the continuous rotation engine being able to drive rotating the eight sets of the gear-drive eccentric top-raised cylinder drives and enhance power output instantly within a 360 degree cycle operating twice the processes of intake, compression, power and exhaust, so as to increase the vehicle engine speed continuously and relatively reduce the basic fuel consumption less than half of a traditional vehicle does;
the rotation flywheel cylinder of the present invention relating to a rotating cycle of the eight sets of the gear-drive eccentric top-raised cylinder drives being able to operate and output twice vehicle power cycles of intake, compression, power and exhaust, so as to increase the operation speed of the cylinder drives themselves with only a short distance movement, further to enhance the rotation acceleration force, and then relatively to reduce the fuel consumption hugely.

2. The device according to claim 1, wherein the engine is able to be used in a car.

3. The device according to claim 1, wherein the engine is able to be used in a generator.

4. The device according to claim 1, wherein the engine is able to be used in one or more than two (including two) attached together as one unity.

5. The device according to claim 1, wherein the teeth inside the engine are able to be increased in multiple to raise the cylinder output power.

6. The device according to claim 1, wherein the eight sets of the gear-drive eccentric top-raised cylinder drives of the engine is able to be doubled to sixteen sets to gain the power more than twice the engine output in a cycle.
